(19) United States
(12) Patent Application Publication
(10) Pub. No.: US 2004/0261312 A1
(43) Pub. Date: Dec. 30, 2004

(54) Drop-shot fishing hook

(76) Inventor: Gary N. Ravencroft, Paradise, CA (US)

Correspondence Address: Gary N. Ravencroft, 5011 Ravelle Court, Paradise, CA, 95969, US

(21) Appl. No.: 10/876,900

(22) Filed: Jun. 24, 2004

Related U.S. Application Data
(60) Provisional application No. 60/483,524, filed on Jun. 26, 2003.

(51) Int. Cl. A01K 83/06

(52) U.S. Cl. 43/44.83

(57) ABSTRACT

A fishing hook formed such that two lines can be attached to the hook, with the first line also connecting to the fishing pole reel and the second flexible line also connecting to a weight or sinker. The locations at which the lines are attached are positioned relative to one another, a main shank, lever arm and the hook such that the sinker pulls the hook structure at a certain location causing a predicable pivoting or rotating, wherein a lever and fulcrum are in effect, to swing the main shank and hook into an outward raised position well suited for both displaying of the bait and hooking of fish. The assemblage can be cast or jigged vertically up and down. Snagless arrangements are also taught wherein the hook point is buried or slightly covered in the bait.

### CROSS-REFERENCE TO RELATED APPLICATIONS

The Priority benefit of my pending U.S. Provisional Application No. 60/483,524 which was filed Jun. 26, 2003 is claimed for this Application.

### BACKGROUND OF THE INVENTION

1) Field of the Invention

This invention relates to fish hooks of the type which are connected to fishing line and baited with artificial or natural bait to entice a fish to bite and become hooked, thereby allowing the fish to be caught.

2) Description of the Related Prior Art

There are many types of fishing hooks available in the market. None are known to Applicant to be structured the same or to be used the same as the present invention. Applicant owns the invention titled “Rattle bait fishing lure” of U.S. Pat. No. 6,155,000 issued Dec. 5, 2000 in which the U.S. patents listed on the herewith Information Disclosure Statement are on the first page thereof and might be relevant. Applicant requests a thorough prior art search by the US Patent and Trademark Office.

Drop-shot fishing is known in the prior art, and the present invention most closely relates to drop-shot fishing, as the methods of jigging up and down or casting and retrieving are the same with the present invention and prior art drop-shot fishing. Persons using the drop-shot method of fishing attach a fish hook to the fishing line a foot or two from the end using various line tie methods, then attach a sinker to the end of the line. I say a foot or two but it could be up to 10 feet or more but that makes it harder to get the sinker near enough to grasp as the hook hits the eye on the pole when retrieving the entire assemblage. Then typically a plastic or rubber worm is usually placed on the hook intended to stay in a lengthwise level or horizontal position. The rigged system is then lowered to the bottom, typically by letting line off of the reel attached to the fishing pole, and shaken or moved up or down slightly imparting motion to the worm to attract fish. The most common knot used to tie the hook onto the fishing line is the Palomar knot. The same main line, in the prior art, extends downward from the Palomar knot at the hook to then be tied or otherwise connected to the sinker now located at the lower most end of the assemblage. The “desired” hook position is with the hook shank pointing straight out or 90 degrees from the line with the curved hook portion and the point of the hook in an upward position, i.e., the hook curving upward away from the ocean or lake bottom then turning inward to aim the point of the hook at the fishing line a short distance away and with the hook ideally residing vertically above the horizontal shank. The “desired” position while not readily achieved with prior art hooks does greatly enhance the “catch to bite” ratio as fish are usually hooked in the top or corner of the mouth. The problem is that it is almost impossible when tying the prior art hooks to the line to achieve the proper or desired hook position. After tying the hook to the line, the hook end can end up in any position including completely upside down and or laying closely adjacent the line. This can reduce the catch ratio to almost zero. The hook should be positioned with the point above the shank and the hook standing out from the line at approximately 90 degrees in relation to the fishing line, the line typically being vertical, extending down from the tip of the fishing pole into the water and toward the ocean, sea, river or lake bottom. With less than the desired hook positioning, many times a fish is not hooked after biting due to the poor position of the hook in relation to the fishing line. For instance, if a hook is positioned on the line with the point and shank horizontal, the hook can be pulled out of the fish's mouth, sliding between the lips, wherein the fish escapes. Fish mainly remain positioned generally with their lips horizontal, much like a standing human. A horizontal hook can slide out between a fish's horizontal lips. The fish tongue somewhat fills the lower part of the mouth so the upper part above the upper lip is more open (a cavity) and thus it is more desirable and will hook the fish more often to have the hook up above the shank than curving downward below the shank, the result ideally will be the fish hooked in the upper lip.

### SUMMARY OF THE INVENTION

This Application claims the Priority benefit of my U.S. Provisional Application No. 60/483,524 which was filed Jun. 26, 2003 and which is herein incorporated by reference in its entirety.

The present invention is a fishing hook improved in its structural shape and connection to fishing line primarily for the drop-shot method of fishing. The present invention is from one viewpoint a fish hook, and from another viewpoint an assemblage of a particular structure of fish hook connected to fishing lines in a particular arrangement. A novel process of manufacturing a fish hook type description is also herein provided.

The present hook includes two separated or spaced apart line tie areas, a long or main shank and a short or lever arm shank which when pulled downward by the sinker pivots the main shank with attached hook into a horizontal position relative to the line attached to both the fishing pole and present hook.

The present invention holds or aids in holding the hook in the optimum position, properly maintaining the “desired” positioned to thereby greatly increase the hook to bite ratio. Another advantage over prior art drop-shot arrangements is that with the present invention a light or lighter tensile strength line can be used to connect the weight or sinker than is used to connect the hook to the reel on the fishing pole. This allows the lighter line to break to leave a snagged sinker behind allowing retrieval of the main line and hook.

### BRIEF DESCRIPTION OF THE DRAWINGS

FIG. 1 is a side view of a hook in accordance with the invention. The hook is shown flat or all laying in the same plane although the lower eye could be rotated from that plane if desired.

FIG. 2 is a side view of the FIG. 1 hook attached to a first line and a second line having a sinker on the second line in an assemblage in accordance with the invention. The lines are shown tied to a first bent area and a second bent area, one line per area, with the bent area retaining the lines in the proper location.

FIG. 3 is a side view of the FIG. 1 hook attached to a first line and a second line with a sinker on the second line, and with a bait attached on the hook in an assemblage in accordance with the invention.

FIG. 4 is a side view of a hook in accordance with the invention.

FIG. 5 is a side view of the FIG. 4 hook attached to a first line and a second line with a sinker on the second line in an assemblage in accordance with the invention.

FIG. 6 is a side view of the FIG. 4 hook attached to a first line and a second line with a sinker on the second line, and with a bait attached on the hook in an assemblage in accordance with the invention.

FIG. 7 is a side view of a hook in accordance with the invention.

FIG. 8 is a side view of the FIG. 7 hook attached to a first line and a second line with a sinker on the second line, and with a bait attached on the hook in an assemblage in accordance with the invention.

### BEST MODES FOR CARRYING OUT THE INVENTION

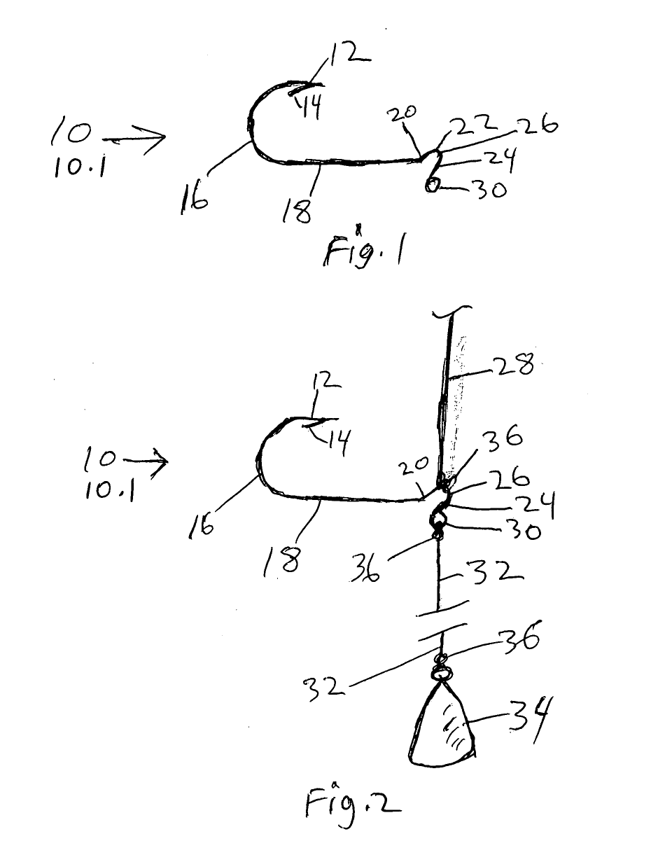

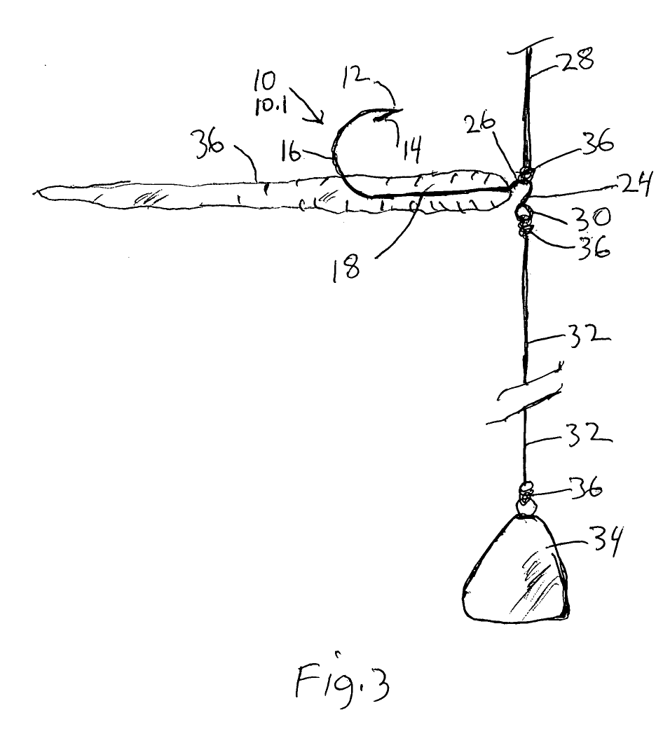

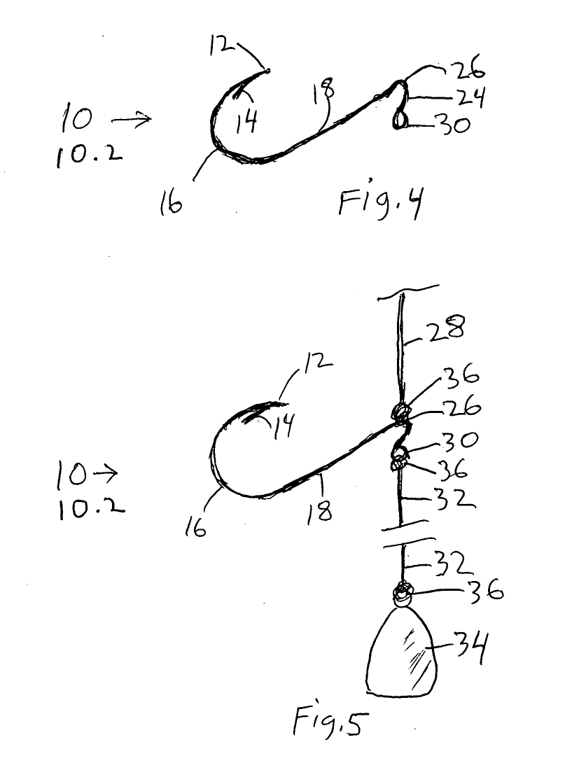

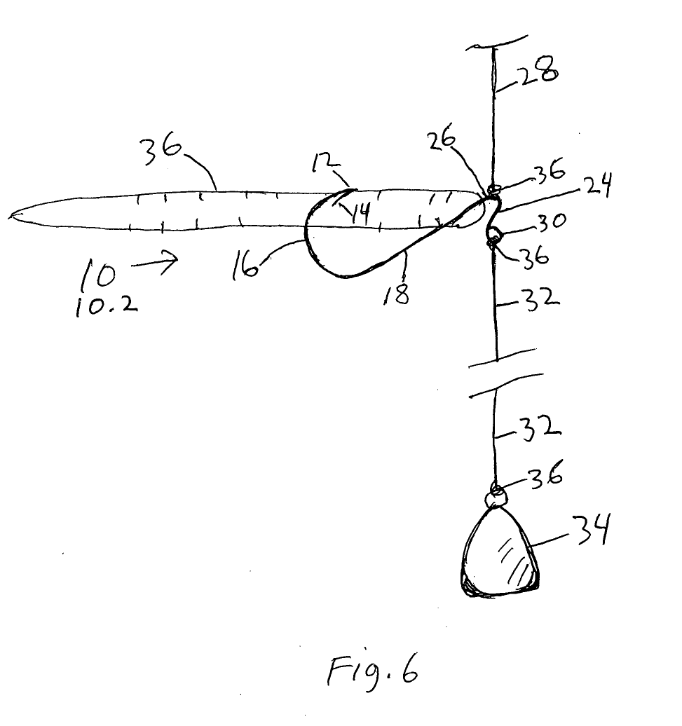

See FIGS. 1-3 for my most preferred embodiment and assemblage. Structural details include the present fish hook 10 can be readily made of metal wire bent and formed (sharpened and barbed where desired). The metal wire may be considered body material, as it would typically be a single diameter wire spooled off of a bulk roll by automatic feeding, bending and cutting machinery. All parts of the hook 10 can be made of a single piece of wire or integrally form of wire. Applying barbs can be done with a strike tool, and the sharp point can be applied with a cut-off or strike tool and with abrasives, lasers or other tools and processes to ensure the point is sharp. Tempering or the like to harden or make the wire hook strong enough can be applied. The wire material used to form the fish hook 10 can be circular in cross section or square, rectangular, oval, triangular, etc. in cross section. At one end of the hook 10 structure is a sharp point 12 which may if desired have an adjacent barb 14 formed. From point 12 the wire extends into a curved hook 16 curving back under itself and then straightens into long or main shank 18 which extends a distance to a bent line tie area comprising in one form a first bend upward 20 which then curves back in curved portion 22 and extends downward relative to point 12 to extend downward in vertical shank 24 perpendicular to shank 18. Shank 24 is to be called or considered a short shank or lever arm as will become increasingly appreciated. The material forming bends 20, 22 and downward extension from 22 extends into shank 24, 24 is a lever arm, and then into the material defining eye or eyelet 30. Formed is an upper line tie bend 26 which is an area on hook 10 structure to tie the first or upper line 28 extending from the fishing pole downward to the hook 10, see FIG. 2. Upper line tie bend 26 traps, due to the bent nature or raised bent nature, the line tied thereon generally preventing it from slipping out of the line tie area. Upper line tie bend 26 can be herein referred to as an area and also can be formed by bending or otherwise fashioning a loop. Bend or area 26, the material thereof, gives structure to which to tie the line from the fishing pole, thereby securing hook 10 structure to the pole, and also serves as a fulcrum or pivot point as will be appreciated with further reading. Shank or lever arm 24 extends downward a short distance and the wire material is then bent or otherwise formed into an eye or eyelet 30 providing material about which to tie or otherwise secure or attach (clip) a second line 32. Line 32 extends downward six inches to ten feet or so depending on conditions such as bottom weeds or how far off of the bottom the fish are swimming, although a typical normal length of line or second line 32 will be about a foot or two, as that will work best most of the time. The lower end or portion of second line 32 is connected, tied, clipped pressed or whatever works well to a weight normally called a sinker 34. Knots 36 are shown in FIG. 2 where the fishing lines 28 and 32 are attached to the hook 10 and sinker 34. Eyelet or eye 30 provides a second bent portion or area to attach a line in a trapped or retained manner, and is spaced a distance from the first bent area 26 a distance equal to a minimum of say about 10 percent of the length of long shank 18. The hooks 10 can be made in a variety of sizes but even in a small version I would think a minimum length or distance between the two line tie area 26 and 30 might be 5 millimeters as shank or lever arm 24 serves as a lever, and the longer the lever the greater the leveraged strength, so the weight of the sinker can also be factored into the length of shank 24 in the a very heavy weight would allow a shorter shank 24 length or spaced between the two line attachment points 26 and eye 30. As shown in FIG. 2 lines 28 and 32 align themselves into or along a single co-extensive axis as the weight of sinker 34 pulls on eyelet 30 causing pivoting of hook 10 relative to line 28 in the area of upper line tie bend 26 wherein shank 24 serves as a lever arm levering or pivoting or rotating bend 26 relative to line 28 and swinging main or long shank 18 upward to a horizontal position perpendicular. That perpendicular position is nicely outward from the first and second lines 28, 32 with hook 16 vertically positioned so as to not be likely to slip between horizontal fish lips and to be likely to hook a fish in the mouth region when the fish strikes at the bait, see FIG. 3. Because of the length of shank 18 the point 12 is well spaced from the line 28 too. The weight of sinker 34 and the length of shank section 24 which serves as a lever must of course be sufficient to cause pivoting of shank 18 outward away from the fishing lines. I prefer shank 18 to be straight out relative to the lines, but it can be structure as shown in FIGS. 4-5 at an angle, for example, allowing a weedless or snaggless attachment of a bait 36 shown as a rubber worm in the drawings wherein the point 12 is in the body of the bait. Bait 36 could be many different fish attractants natural or artificial and could be a small fish, etc. as drop shot fisherman already know because drop shot fishing is known, just not with the hook or assemblage of this disclosure. See FIG. 6 which is a weedless arrangement relative to FIG. 3. It can be seen in FIG. 6 that the hook point 12 is still separated from the line 28, sinker 34 has caused pivoting to align the two fishing lines 28 and 32 to extend in the same straight line wherein shank 18 extends outward from the lines 28 and 32 but not perpendicularly as in FIG. 2, but at an angle which can vary widely within the scope of the invention, however 45 to 30 degrees would be reasonable, plus or minus 10 degrees either side of those amounts or from the FIG. 2 shown ninety degrees relative to the axis of the fishing lines 28, 32, but keep in mind the hook 12 and 16 portions when too close to the fishing line makes it more difficult for the fish to get it in his mouth. In FIG. 6 the shank 18 is angled and the rubber worm 36 is perpendicular to lines 28, 32 with the point 12 hidden or protected in the body of the worm 36. Here the worm will extend outward nicely, the hook is still ready to be bitten by the fish, wherein the point 12 is away a good distance from the lines, and the worm will flop up and down when the fisherman or woman quickly raises and then lowers the pole tipped in a repetitively fashion.

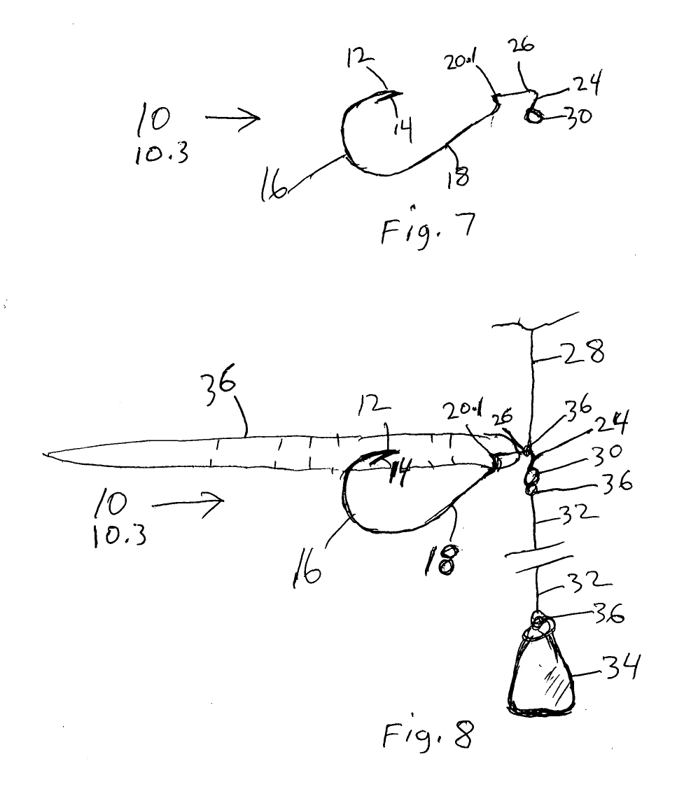

Hook 10 of FIGS. 1-3 can be considered a first embodiment 10.1 for example, FIGS. 4-6 can be considered to show a second embodiment 10.2 for example, and FIGS. 7-8 can be considered to show a third embodiment 10.3. In the hook 10.3 structure of FIGS. 7 and 8 the principles are basically the same as with 10.1 and 10.2 but the area 20.1 extends back toward the hook point 12 before turning back into a horizontal portion 22.2 which then turns downward providing a downward extending lever 24 terminating into the eyelet 30. The hook structure of FIG. 7 as shown in FIG. 8 provides a sharply bent area on which to hook and somewhat hold the head of the rubber worm 36 (bait) in a snaggless or weedless arrangement. Hybrid or embodiments with worm head holding bends as in FIG. 7 can be combined with perpendicular shank 18 embodiments within the scope of the invention. Perpendicular as herein used does not require a perfect 90 degrees or perfect perpendicularity, but could be 90 degrees one axis to another. A second hook structure 10 could be on the second line and a weight 34 connected to it with a second line wherein the assemblage would have two or more hooks 10 and one sinker at the bottom end of the assemblage. Clips like used with snap connect swivels could be used instead of directly tying the lines to the hook 10, particularly if bend 26 was a loop line bend 30. A double or treble type hook can be applied to shank 18 to provide multiple hooks 16, 12 within the scope of the invention. The herein details are not intended to be restrictive but rather are intended to be informative. A fish hook 10, 10.1, 10.2, 10.3 according to the present invention can be considered to be, at least from one possible viewpoint of several possible viewpoints, a body material such a metal wire for example defining a main shank 18, the body material extending from a first end portion of the main shank 18 to define a sharp hook 16, 12, the body material extending from a second end portion of the main shank 18 to define a first bent portion 26, the first bent portion 26 providing material on which to attach and trap a first line 28, the body material extending from the first bent portion 26 angled relative to the main shank to define a lever arm 24, the body material extending from the lever arm 24 to define a second bent portion 30, the second bent portion 30 providing material on which to attach and trap a second line 32, the second bent portion 30 positioned a distance from the first bent portion 26.

A fish hook 10, 10.1, 10.2, 10.3 according to the present invention can be considered to be, at least from one possible viewpoint of several possible viewpoints, manufacturable with a process of manufacturing a fish hook comprising: providing a main shank 18; providing a sharp hook 16, 12 attached to the main shank 18; providing a first bent portion 26 attached to the main shank 18; the first bent portion 26 suitable for attachment of a first line 28; providing a lever arm 24 attached to the first bent portion 26; providing a second bent portion 30 attached to the lever arm 24, and providing the second bent portion 30 being spaced apart in location from the first bent portion 26; the second bent portion suitable for attachment of a second line 32. An assemblage according to the present invention or the present invention can be considered to be, at least from one possible viewpoint of several possible viewpoints, a main shank 18; a sharp hook 16, 16 attached to the main shank 18; a first bent portion 26 attached to the main shank 18; a first line 28 attached to the first bent portion 26; a lever arm 24 attached to the first bent portion 26; a second bent portion 30 attached to the lever arm 24; a second line 32 attached to the second bent portion 30; the second bent portion 30 held spaced apart in location from the first bent portion 26 by the lever arm 24; the second bent portion 30 is positioned vertically below the first bent portion 26 when the sharp hook 16, 12 is positioned above the main shank 18; a sinker weight 34 attached to the second line 32, and a bait 36 attached on shank 18 and hook 16.

In use the sinker 34 being heavy is the lowest portion of the assemblage in the water, or furthest out portion if cast laterally, and the fisherman moves his rod tip up and down to in effect cause the worm 36 flip or wag up and down in a very enticing manner, or if cast retrieves the assemblage in a stop and go fashion. The hook being vertical, i.e., the shank 18 lower than curve 16 raising up to position point 12 above shank 18 is best for hooking fish because horizontal hooks might slide out between horizontal fish lips. The hook 10 arrangement in accordance with the invention can be cast and retrieved wherein the line from the pole extends at an angle, or the hook 10 arrangement can be lowered straight into the water from a dock, boat or rock and “jigged” up and down in the typical drop shot fishing motions.

The details provided are intended to be mainly informative rather than restrictive of the scope of the invention.

I claim:

1. A fish hook comprising:
body material defining
a main shank, the body material extending from a first end portion of the main shank to define
a sharp hook, the body material extending from a second end portion of the main shank to define
a first bent portion, said first bent portion providing material on which to attach and trap a first line, the body material extending from said first bent portion angled relative to said main shank to define
a lever arm, the body material extending from said lever arm to define
a second bent portion, said second bent portion providing material on which to attach and trap a second line, said second bent portion positioned a distance from said first bent portion.

2. A fish hook according to claim 1 wherein said angled relative to said main shank is perpendicular.

3. A fish hook according to claim 1 wherein the distance from said second bent portion to said first bent portion is a minimum of 10 percent of an overall length of said main shank.

4. A fish hook according to claim 1 wherein the distance from said second bent portion to said first bent portion is a minimum of 5 millimeters.

5. A fish hook according to claim 4 wherein said sharp hook includes a barb.

6. A fish hook according to claim 4 wherein said body material is metal wire.

7. A fish hook according to claim 6 wherein said main shank, said sharp hook, said first bent portion, said lever arm and said second bent portion are all integrally formed of a single piece of said wire.

8. A fish hook according to claim 7 wherein said second bent portion is positioned vertically below said first bent portion when said sharp hook is positioned above said main shank.

9. A fish hook comprising:
a main shank;
a hook on said main shank;
a first bent portion line tie area connected to said main shank;
a second bent portion line tie area;
a lever arm angled relative to said main shank, said lever arm connecting to the first bent portion line tie area and the second bent portion line tie area, said lever arm supporting the line tie areas in spaced relationship to one another.

10. A fish hook according to claim 9 wherein the spacing between the first bent portion line tie area and the second bent portion line tie area is a minimum of five millimeters.

11. A process of manufacturing a fish hook comprising:
providing a main shank;
providing a sharp hook attached to the main shank;
providing a first bent portion attached to said main shank; said first bent portion suitable for attachment of a first line;
providing a lever arm attached to said first bent portion;
providing a second bent portion attached to said lever arm, and providing said second bent portion being spaced apart in location from said first bent portion; said second bent portion suitable for attachment of a second line.

12. A fish hook assemblage comprising:
a main shank;
a sharp hook attached to the main shank;
a first bent portion attached to said main shank;
a first line attached to said first bent portion;
a lever arm attached to said first bent portion;
a second bent portion attached to said lever arm;
a second line attached to said second bent portion;
said second bent portion held spaced apart in location from said first bent portion by said lever arm;
said second bent portion is positioned vertically below said first bent portion when said sharp hook is positioned above said main shank;
a weight attached to said second line.
